(19) United States
(12) Patent Application Publication
(10) Pub. No.: US 2012/0249014 A1
(43) Pub. Date: Oct. 4, 2012

(54) CIRCUIT FOR LEAKAGE-CURRENT ELIMINATION IN LED T8 FLUORESCENT TUBE

(75) Inventor: Milan Mei, Shenzhen (CN)

(73) Assignee: GRE ALPHA ELECTRONICS LTD., Hong Kong (HK)

(21) Appl. No.: 13/075,177

(22) Filed: Mar. 29, 2011

(51) Int. Cl. H05B 41/285; F16P 3/00

(52) U.S. Cl. 315/307; 307/328

(57) ABSTRACT

An electric-shock protection circuit that incorporates a PWM start-up control circuit for controlling the start-up of the PWM controller IC. When an electric-shock current test is conducted, the PWM start-up control circuit prevents the starting up of this PWM controller IC. This circuit is realized by resistors, capacitors and switches. In order to achieve protection, the switches perform an operation that different electric paths are activated for a supply voltage condition of around 90-149Vac and another condition of around 150-264Vac. The circuit disclosed in this invention: can be used in the electric-shock current test with a wide range of supply voltage; can ensure that the peak value of the shock current is lower than the safety threshold for human bodies; and can solve the problem encountered in carrying out the test of Standard UL935 where one end of the LED light tube is connected to the electric grid.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CLAIM FOR FOREIGN PRIORITY

This application claims priority under 35 U.S.C. §119 to the China patent application 201120042268.3, filed Feb. 18, 2011, the disclosure of which is incorporated herein by reference.

### FIELD OF THE INVENTION

The present invention relates generally to electric-shock protection circuits for light emitting diode (LED) light tubes. In particular, this invention is related to a circuit that allows lighting fixtures using LED light tubes to satisfy the requirements in electric-shock current tests.

### BACKGROUND

As energy conservation becomes today's mainstream philosophy on environment-friendly living, the promotion of LED lighting technology has become one of the goals in many countries. As such, solutions for solving the problems encountered in the installation of LED light tubes to replace, for example, T8 fluorescent tubes, has become a major research objective. One of these problems is the strict requirement that must be satisfied by LED lighting fixtures to pass an electric-shock current test, which is mandatory in many countries.

FIG. 1 illustrates the method currently used in Standard UL935 for conducting an electric-shock current test. Consider the Electric Grid c as an example. Case-to-ground leakage current can be measured by connecting the ballast case (outside support trunk 1) and electrical ground, which is connected to Electric Grid c. In another example, if Electric Grid d is considered, the grid is connected to the metal-foil test point b, which is then connected to electrical ground. The two aforementioned methods cannot be applied when it is required to conduct an electric-shock current test in which one end is connected to an electrical grid and the other end is connected to a hand, as shown in the test point a of FIG. 1. In this test, the resistance of a human body is about 500 ohms.

In order to ensure the safety of installation personnel in the installation of LED light tubes, it is required to guarantee that the peak current flowing through a human body in an electric shock does not exceed 7.07 mA for a typical electric grid having a frequency of 60 Hz or below 60 Hz. Note that the parameters used in electric grids all over the world are different. The AC input voltage supplied to the light tube and also to the lighting fixture has a wide range from 90V to 264V. The invention disclosed herein is applicable to an electric-shock current test under a wide range of power supply voltages.

As such, there is a need to conduct the electric-shock current test where one end is connected to an electric grid and the other end emulates the connection to a human body. The invention disclosed herein is able to ensure the safety of installation personnel, and to satisfy the shock-current requirement of Standard UL935 under a wide range of AC power supply voltages.

### SUMMARY

Concerning the aforementioned problem, the present invention provides a pulse-width-modulation (PWM) start-up control circuit, and a protection circuit that incorporates such PWM start-up control circuit. Using the protection circuit enables installation personnel to safely install an LED light tube when one end of the tube is already connected to the electric grid, and also allows the shock-current requirement of Standard UL935 to be satisfied under a wide range of power supplies from 90V to 264V.

In the disclosed invention, the PWM start-up control circuit is used to control the start-up of the PWM controller integrated circuit (IC). This PWM start-up control circuit has the following characteristics. The control circuit incorporates a protection circuit that prevents the PWM controller IC from starting up when the electric-shock current test is conducted. The protection circuit is composed of electronic components such as resistors, capacitors and switches. The switches are closed or open according to the AC supply voltage. Two different electric paths are formed, one for a voltage of range around 90-149V_{ac} and the other for around 150V-264V.

The electrical circuit that incorporates the aforesaid PWM start-up control circuit further comprises an electromagnetic interference (EMI) filter, an AC/DC rectifier, a PWM controller IC and a DC/AC converter, wherein the input ports of the EMI filter are connected to the AC power supply, and the output ports of this EMI filter are connected to the PWM start-up control circuit via the AC/DC rectifier. When conducting the electric-shock current test, the PWM start-up control circuit is series connected, via the DC/AC converter, to the equivalent resistance of a human body.

A benefit of this invention is to provide a low-cost test solution. The circuit disclosed in this invention: can be used in the electric-shock current test with a wide range of supply voltages; can ensure that the peak value of the shock current is lower than the safety threshold for human bodies; and can solve the problem encountered in carrying out the test of Standard UL935 where one end of an LED light tube is connected to the electric grid.

### BRIEF DESCRIPTION OF THE DRAWINGS

Embodiments of the invention are described in more detail hereinafter with reference to the drawings, in which

FIG. 1 is a schematic diagram showing a method currently used in Standard UL935 for conducting an electric-shock current test;

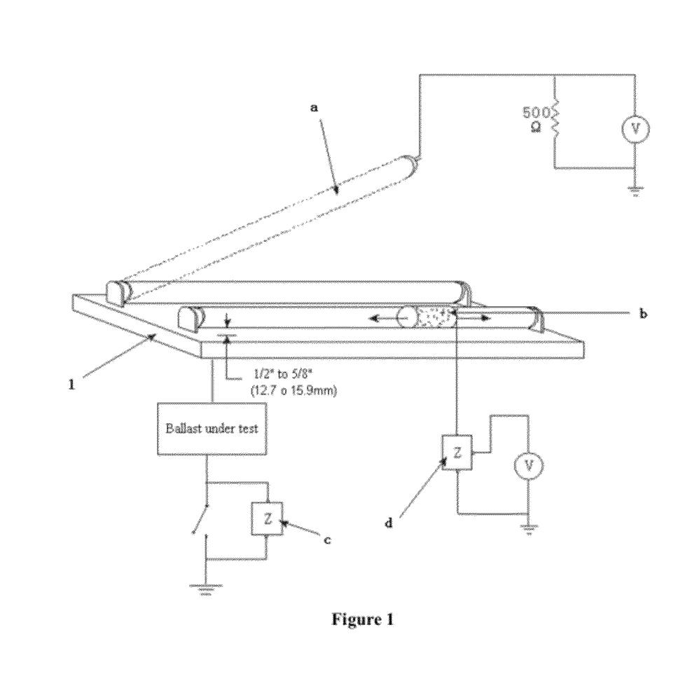

FIG. 2 shows a power supply for driving an LED light tube, where the power supply incorporates an embodiment of the present invention;

FIG. 3 shows an electric circuit of an EMI filter incorporated in the embodiment of the present invention;

FIG. 4 shows an equivalent circuit that models the system involved in an electric-shock current test specified in Standard UL935; and

FIG. 5 shows a PWM start-up control circuit incorporated in the embodiment of the present invention.

### DETAILED DESCRIPTION

In the following description, electric-shock protection circuits for LED light tubes and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

For an electric grid using a frequency of 60 Hz or below 60 Hz, the maximum current level that ensures human safety in case of an electric shock is 7.07 mA. Alternatively, human safety can be ensured if the current from the AC input is limited to less than 7.07 mA. In practice, however, taking into consideration the safety margin and the variation of components values from one item to another during the manufacturing process, the peak current of the AC input is usually limited to 80% of 7.07 mA. The preferred value is below 6 mA, and the optimal one is below 5.5 mA. For circuits used in existing lighting fixtures that employ LED light tubes, it is difficult to limit the current level to below the aforementioned peak value when an electric shock happens to installation personnel. This invention solves this problem by making the most of the existing electric circuit under the goal of keeping a low cost. In particular, this problem is solved by adjusting the values of components in the existing electric circuit together with providing a new PWM start-up control circuit.

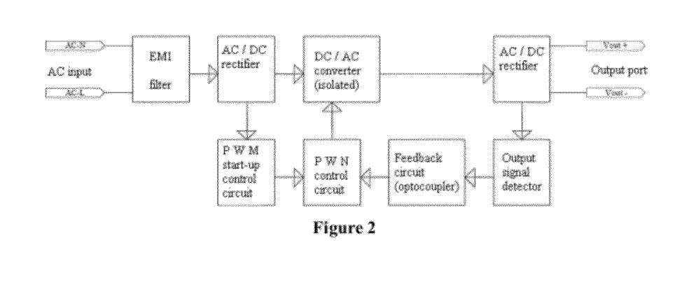

FIG. 2 is a block diagram showing an implementation, in accordance with the present invention, of a power supply that is to drive the LED light tube. In this implementation, the AC power is first sent to an EMI filter. The filtered AC power is then fed to a cascade of a first AC/DC rectifier, a DC/AC converter, and a second AC/DC rectifier. The output of the second AC/DC rectifier is connected to the load. In the implementation, the PWM start-up control circuit is connected to the PWM controller circuit. The AC/DC rectifier can be realized by four diodes (for example: IN4007 diodes) that form a full-wave rectification circuit. Between this rectifier circuit and the AC input is the EMI filter. The EMI filter typically comprises a capacitor discharge circuit and a passive EMI processing circuit. In addition, the PWM controller IC in the PWM controller circuit can be realized by, for example: IC with model number ST L6561 and OB SN03ACP.

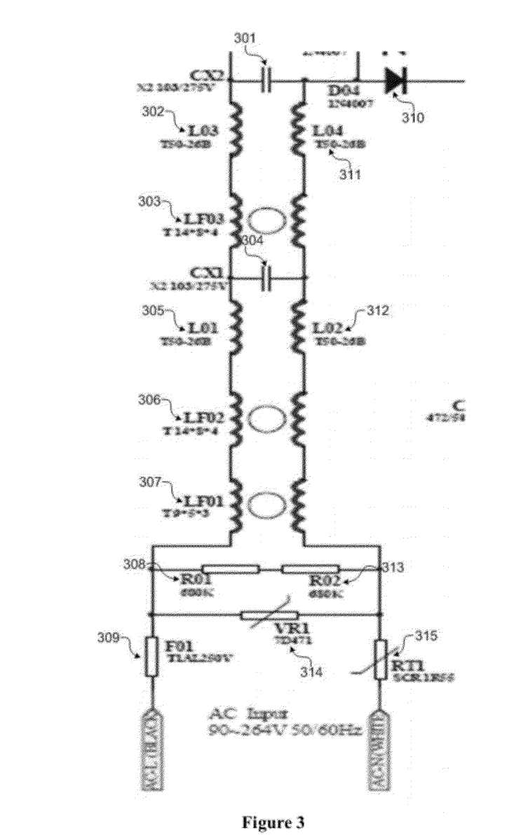

FIG. 3 is a circuit diagram of an EMI filter incorporated in an embodiment of the present invention. In this circuit, the AC input is connected in parallel to R01 308 and R02 313, forming a discharge path for the total capacitance X (contributed by capacitors CX1 304 and CX2 301) of the EMI filter. The EMI processing circuit comprises a plurality of inductors and capacitors. When the voltage of the AC input is 264V_{ac}, it is possible, by using components with appropriate values, to control the current that passes through the discharge circuit and the EMI processing circuit to under 2 mA. It is known that the impedance of a capacitor is calculated by:

X_{c}=1/2πfC,

where X_{c} is the capacitive reactance value, f is the frequency, and C is the capacitance.
In order to ensure that the peak value of the total input current does not exceed the aforementioned peak value, the total capacitance at the input side of the EMI filter input cannot exceed 0.08 μF. After testing and verification, and taking into consideration the issue of cost in the manufacturing of EMI filters, the total capacitance X at the input side of the EMI filter is preferred to be less than 0.03 μF.

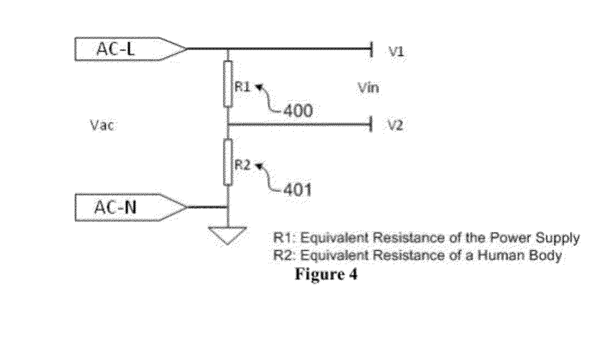

FIG. 4 is an equivalent circuit of a configuration used in the electric-shock current test specified in Standard UL935. In conducting the test, the equivalent resistance of a human body R2 401 is around 500 ohms. This equivalent resistance R2 401 is serially connected to the equivalent resistance of the power supply R1 400. The actual AC voltage input to the power supply is given by Vᵢₙ=V_{ac}×[R1/(R1+R2)], where V_{ac} is the voltage of the AC input, and Vᵢₙ is the actual voltage appearing to the power supply. From this formula, it is observed that when the equivalent resistance of a human body R2 401 is inserted, Vᵢₙ is lower than V_{ac}, so that the input voltage of the power supply is reduced. Based on this observation, and according to Ohm's law, it is found that the actual start-up current supplied to the PWM controller IC in the PWM control circuit is also reduced, further discouraging the proper functioning of the PWM controller IC.

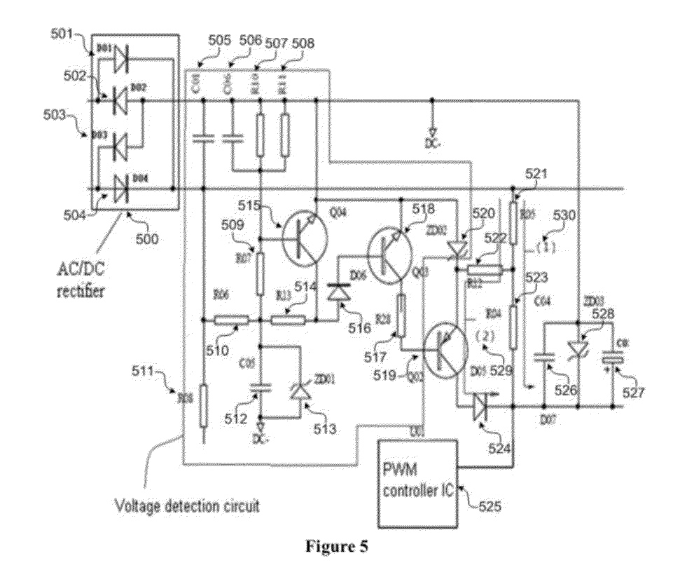

FIG. 5 is a circuit diagram of the PWM start-up control circuit incorporated in the embodiment of the present invention. It is observed that after the PWM controller IC U01 525 in the PWM control circuit is started up properly, the AC input current will be increased significantly, thereby greatly exceeding the preferred maximum current of 7.07 mA. In order to solve the problem encountered in the electric-shock current test, and to ensure human safety during installation of LED light tubes, the present invention reduces the AC input current by preventing the PWM controller IC U01 525 from starting up by means of reducing the time required to start the PWM start-up control circuit, which can inhibit the starting of the PWM controller IC, and reducing the start-up current.

The capacitor for start-up, for example, the start-up capacitor C02 527, is used to provide electrical energy to the PWM controller IC U01 525 during start-up. When the voltage at the capacitor C02 527 reaches the start-up voltage required for the PWM controller IC U01 525, this IC will be started up. If the capacitance of the capacitor C02 527 is larger, there is more stored energy so that the time for sustaining the start-up process of the IC U01 525 is longer and, hence, the start-up of the PWM control circuit is made easier. In order to reduce the time of supporting the start-up process of the IC U01 525, one can reduce the capacitance of the capacitor C02 527. However, it is also required to guarantee that the IC U01 525 and the PWM control circuit have adequate time and energy to ensure proper start-up during normal uses (for example, not under the electric-shock current test, and not under installation of LED light tubes); otherwise system instability may occur. It implies that the capacitance of the capacitor C02 527 cannot be too small. After practical tests and verification, the capacitance of the start-up capacitor C02 527 can be selected to be a value of from 4.7 μF to 15 μF for the case of a 25 W T8 LED light tube as an example.

In addition, it is preferable to avoid providing a start-up current that is greater than the amount required for the starting up of the IC U01 525 plus a certain margin that accounts for random variation of component values due to manufacturing non-uniformity. Since the present invention is intended for use over a wide range of supply voltages, the PWM start-up control circuit shown in FIG. 5 provides two electrical paths—(1) 530 and (2) 529—that are activated according to the input supply voltage. The two paths are used for providing the start-up current to the IC U01 525. The range of supply voltages is partitioned into two parts: 90-150V and 150-264V. When the input supply voltage is within 150-264V, the path (1) 530, including the resistors R05 521 and R04 523, is activated. If the input supply voltage is within 90-150V, the resistors R05 521 and R12 522, the transistor Q02 519 and the diode D05 524 are activated, activating both paths (1) 530 and (2) 529 so that the start-up current is provided by these two paths. Even if the AC input voltage is reduced, the start-up current for the IC U01 525 can still be maintained. In path (2) 529, the resistor R12 522 is connected to the emitter of the transistor Q02 519, the collector of the transistor Q02 519 is connected to the anode of the diode D05 524, and the base of the transistor Q02 519 is connected to the voltage detection circuit. The voltage detection circuit, which can be implemented by a comparator, activates the path (2) 529 in the case of 90-150V, and deactivates this path when the voltage is within 150-264V.

Table 1 lists the maximum allowable peak current against the frequency of electric grid.

TABLE 1
Maximum Allowable Current In Case of Electric Shock

| | Maximum allowable |
|---|---|
| Frequency (Hz) | current (mA) |
| 60 or below 60 | 7.07 |
| 180 | 8.17 |
| 500 | 8.64 |
| 1000 | 10.76 |
| 2500 | 15.71 |
| 5000 | 23.02 |
| 10000 or above 10000 | 43.45 |

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalents.

What is claimed is:

1. A pulse-width-modulation (PWM) start-up control circuit for controlling start-up of a PWM controller IC comprising:
a protection circuit to prevent operational start-up of the PWM controller IC when conducting an electric-shock current test;
wherein the protection circuit comprises:
one or more resistors,
one or more capacitors, and
one or more switches;
the one or more switches are configured to activate a first electric path when a first supply voltage condition of 90-149V_{ac} is presented and a second electric path when a second supply voltage condition of 150-264V_{ac} is presented.

2. The PWM start-up control circuit of claim 1, wherein the protection circuit comprises:
a resistor,
a transistor, and
a diode;
such that a collector of the transistor is connected to an anode of the diode;
an emitter of the transistor is connected to the resistor; and
a base of the transistor is connected to a voltage detection circuit that detects a voltage level of an electric grid.

3. The PWM start-up control circuit of claim 1, further comprising a start-up capacitor for the PWM controller IC.

4. The PWM start-up control circuit of claim 3, wherein capacitance of the start-up capacitor is within 4.7-15 μF.

5. The PWM start-up control circuit of claim 1, wherein the PWM start-up control circuit is configured for a lighting fixture that employs a T8 LED light tube.

6. The PWM start-up control circuit of claim 1, wherein the protection circuit further comprises:
an EMI filter,
an AC/DC rectifier,
a DC/AC converter, and
the PWM controller IC; and
input ports of the EMI filter are connected to a AC power supply; output ports of the EMI filter are connected to the AC/DC rectifier; and
when conducting an electric-shock current test, the PWM start-up control circuit is serially connected, via the DC/AC converter, to an equivalent resistor of a human body.

7. The PWM start-up control circuit of claim 6, wherein total input capacitance of the EMI filter is less than 0.08 μF.

8. The PWM start-up control circuit of claim 2, wherein the protection circuit further comprises:
an EMI filter,
an AC/DC rectifier,
a DC/AC converter, and
the PWM controller IC; and
input ports of the EMI filter are connected to a AC power supply; output ports of the EMI filter are connected to the AC/DC rectifier; and
when conducting an electric-shock current test, the PWM start-up control circuit is serially connected, via the DC/AC converter, to an equivalent resistor of a human body.

9. The PWM start-up control circuit of claim 8, wherein total input capacitance of the EMI filter is less than 0.08 μF.
